(19) United States
(12) Patent Application Publication
(10) Pub. No.: US 2005/0134529 A1
(43) Pub. Date: Jun. 23, 2005

(54) Color changing segmented display

(76) Inventors: Luiz Lei, Hong Kong (HK); Gorden Wong Chi Biu, Hong Kong (HK)

Correspondence Address: BROOKS KUSHMAN P.C., 1000 TOWN CENTER, TWENTY-SECOND FLOOR, SOUTHFIELD, MI, 48075, US

(21) Appl. No.: 10/739,813

(22) Filed: Dec. 18, 2003

(51) Int. Cl. G09G 3/04; G09G 3/14

(52) U.S. Cl. 345/34

(57) ABSTRACT

A segmented display includes a display including a plurality of segments. Each segment includes a light emitting device operative to produce a plurality of colors. A controller drives the segments on an individual basis to allow selective illumination of segments on the display to provide the desired illumination pattern with the illuminated segments. The segments are driven to produce a dynamic display that creates a color changing effect in various segments when displaying the desired illumination pattern.

### BACKGROUND OF THE INVENTION

1. Field of the Invention

The invention relates to segmented displays wherein displayed letters, numbers, etc. are composed of illuminated segments. The invention also relates to digital clock devices and digital timer devices that often employ these segmented displays.

2. Background Art

The use of segmented displays has become widespread. A typical segmented display includes a plurality of segments. The segments are controlled on an individual basis to allow selective illumination of segments on the display to provide any desired illumination pattern composed of illuminated segments.

These segmented displays are often used in digital clocks and timers to display time. Digital clocks sometimes use additional segments for displaying other information such as month, date, day of week, humidity and temperature, etc.

Traditionally, the illuminated segments produce a simple display that indicates the current time or other information. In some existing applications, a manual dimming switch has been provided to provide a bright mode and a dim mode for the display. In a typical approach, each illuminated segment is illuminated by one or more light emitting diodes (LEDs).

Background information may be found in U.S. Pat. Nos. 5,008,595; 3,481,062; 6,628,249; 6,431,719; 6,639,574; 6,588,132; 6,599,033; 4,870,325; 6,097,367; 4,724,629; and 6,288,696.

### SUMMARY OF THE INVENTION

It is an object of the invention to provide an improved segmented display wherein the illuminated segments provide a dynamic display that creates a color changing effect in various segments when displaying the current time or other information.

In carrying out the invention, a segmented display is provided. The segmented display comprises a display including a plurality of segments, and a controller that drives the segments. The controller drives the segments on an individual basis to allow selective illumination of segments on the display to provide the desired illumination pattern with the illuminated segments. Each segment includes a light emitting device arrangement operative to produce a plurality of colors. The segments are driven to produce a dynamic display that creates a color changing effect in various segments when displaying the desired illumination pattern.

The segmented display may be used in a digital clock or timer to display time. Additional segments may be used for displaying other information such as month, date, day of week, humidity, and temperature, etc. The light emitting device arrangements are preferably made up of light emitting diodes (LEDs).

At a more detailed level, the invention comprehends a light emitting diode (LED) type segmented display. The display includes clusters of LEDs. Each cluster includes LEDs with different colors. Each segment of the LED display includes one or more clusters of LEDs. LEDs may be arranged into different channels. Each channel contains a group of LEDs with one or more colors depending on the application. A microcontroller controls the mixing of different color LEDs at each cluster when driving the segments to generate hundreds of colors and dynamic color change effects in various segments. The microcontroller drives the segments on an individual basis to allow selective illumination of segments on the display to provide the desired illumination pattern with the illuminated segments, while the segments are driven in a manner to produce a dynamic display that creates a color changing effect when displaying the desired illumination pattern.

It is appreciated that mixing of different color LEDs at each cluster may be achieved in a variety of ways. Several embodiments are contemplated.

### BRIEF DESCRIPTION OF THE DRAWINGS

FIG. 1 is an LED display for a simple LED alarm clock of the invention;

FIG. 2 is an LED display for a multi-feature LED alarm clock of the invention;

FIG. 3 illustrates a direct drive LED display circuit;

FIG. 4 illustrates a duplex LED display circuit;

FIG. 5 illustrates a multiplex LED display circuit;

FIG. 6 illustrates a seven segment display and an associated direct drive display circuit as well as the connection to the microcontroller for driving the segments;

FIG. 7 illustrates a seven segment display and an associated duplex display circuit as well as the connection to the microcontroller for driving the segments;

FIG. 8 is a block diagram illustrating the implementation of the direct drive LED display circuit with an LED display; and

FIG. 9 is a block diagram illustrating the implementation of the multiplex LED display circuit with an LED display.

### DETAILED DESCRIPTION OF THE PREFERRED EMBODIMENTS

In FIG. 1, an LED display 10 for a simple LED alarm clock includes a plurality of segments 12. A microcontroller drives the segments 12 on an individual basis. With each segment 12 driven on an individual basis, selective illumination of segments 12 on display 10 provides any desired illumination pattern with the illuminated segments. Each segment 12 includes a light emitting device arrangement that is driven when the segment is driven by the microcontroller. The microcontroller drives the light emitting device arrangements within the segment to be illuminated in such a way to produce a dynamic display that creates a color changing effect in each illuminated segment. The light emitting arrangements are preferably made up of LEDs. In this way, each segment 12 of the LED display 10 includes one or more clusters of LEDs to illuminate that segment. Each LED cluster includes LEDs of different colors. Driving LEDs of different colors in the same segment 12 with varying signals creates the color changing effect.

More particularly, when the controller drives a particular segment, the controller drives each cluster in that segment by varying the brightness of each LED gradually from dim to bright and from bright to dim. When the LEDs are different colors, this can be performed to create a color changing effect for the segment. It is appreciated that the mixing of different color LEDs at a cluster to produce the color changing effect may be achieved in a variety of ways. For example, the LED display may include one or more channels depending on the application. Each segment may include one or more separate connections to the microcontroller depending on the application. The brightness of any particular LED may be controlled in any suitable way such as by varying an analog signal or using a digital timing pulse.

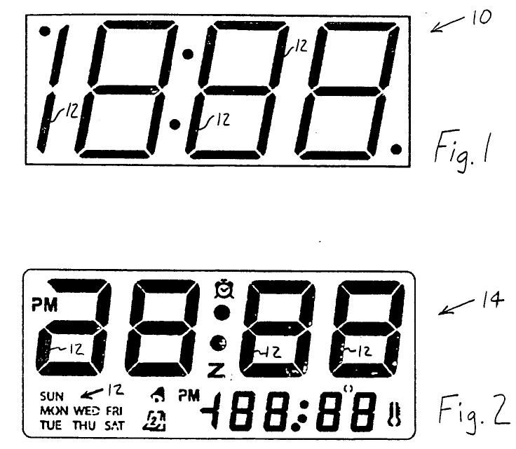

In FIG. 2, an LED display 14 for a multi-feature LED alarm clock is illustrated. Of course, clocks and timers are suitable implementations of the invention but the invention may be applied to any segmented display.

The LEDs inside the displays 10 and 12 may be arranged into one channel, two channels, or any other number of channels depending on the driving method. Each channel contains a group of LEDs. The group of LEDs for a channel may be connected in a common anode arrangement or a common cathode arrangement depending on the application. A channel may contain a single color of LEDs or may contain LEDs of multiple colors depending on the application.

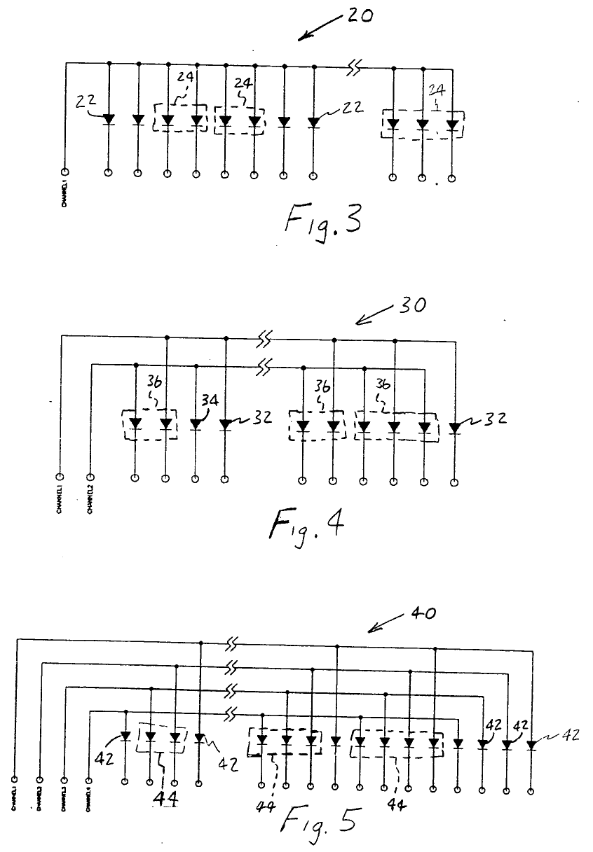

FIG. 3 illustrates a direct drive LED display circuit 20. Circuit 20 contains a group of LEDs 22 in a single channel. The single channel contains LEDs of multiple colors. In this way, the channel group of LEDs may include various clusters 24 of LEDs. Each cluster 24 may contain two or more LEDs with each cluster 24 including LEDs of multiple colors. In this way, one or more clusters 24 are associated with each segment 12 such that each segment 12 is associated with LEDs of multiple colors to allow driving of the segment 12 in a way that produces the desired color changing effect.

FIG. 4 illustrates a duplex LED display circuit 30. Circuit 30 contains LEDs 32 and 34 arranged in two channels. As shown, each channel contains LEDs of a single color or multiple colors. The first channel includes LEDs 32 while the second channel includes LEDs 34. In this way, the LEDs may compose various clusters 36 of LEDs. Each cluster 36 may contain two or more LEDs with each cluster 36 including LEDs of multiple colors. In this way, one or more clusters 36 are associated with each segment 12 such that each segment 12 is associated with LEDs of multiple colors to allow driving of the segment 12 in a way that produces the desired color changing effect.

FIG. 5 illustrates a multiplex LED display circuit 40. Circuit 40 contains LEDs 42 arranged in four channels. As shown, each channel contains LEDs of a single color or multiple colors. In this way, the LEDs may compose various clusters 44 of LEDs. Each cluster 44 may contain two or more LEDs with each cluster 44 including LEDs of multiple colors. In this way, one or more clusters 44 are associated with each segment 12 such that each segment 12 is associated with LEDs of multiple colors to allow driving of the segment 12 in a way that produces the desired color changing effect.

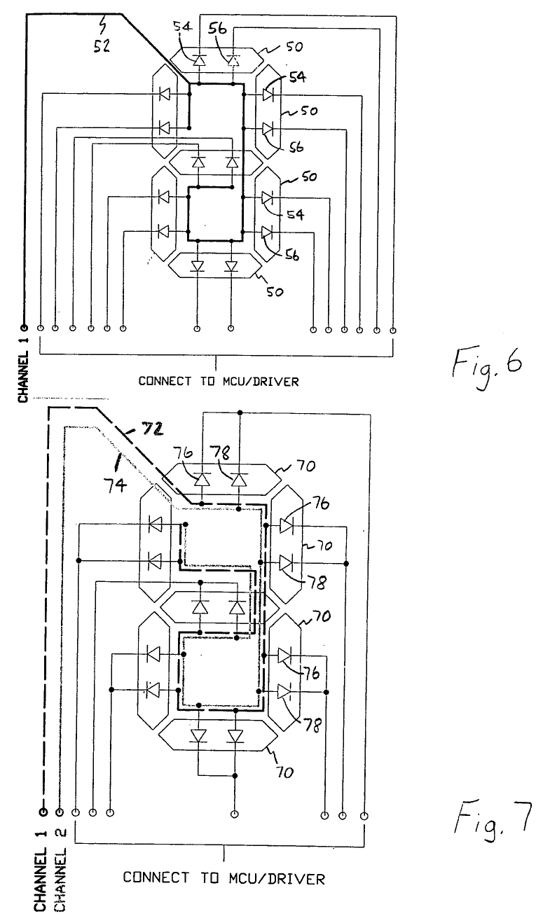

FIG. 6 illustrates a seven segment display with seven segments 50 and an associated direct drive display circuit with all diodes on a single channel 52. Each segment 50 includes a first diode 54 of a first color and a second diode 56 of a second color. The first and second diodes 54 and 56, respectively, connect to the microcontroller (MCU/DRIVER) as indicated.

In this direct drive LED display of FIG. 6, two LEDs with different colors are placed within each segment 50. Alternatively, more than two LEDs can be placed within one segment. There are two methods to make each segment change its color. In a first approach, a digital timing pulse is utilized. The single channel is connected to the positive supply voltage and each LED is connected to the MCU/DRIVER, the MCU/DRIVER will output a chain of timing pulses to control the brightness and also the on/off of each LED. In this way, a color changing effect is realized. In the second approach, analog control is utilized. The single channel is connected to the positive supply voltage and each LED is connected to the MCU/DRIVER, the MCU/DRIVER will output an analog signal to control the brightness and also the on/off of each LED to perform the color mixing function.

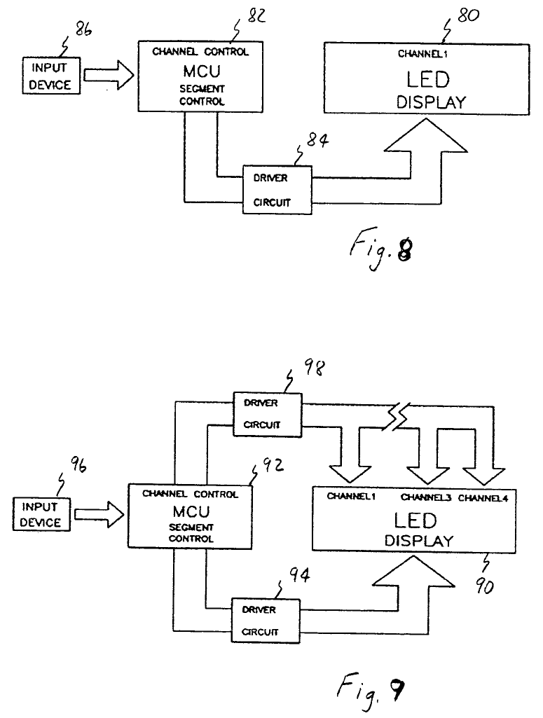

FIG. 7 illustrates a seven segment display with seven segments 70 and an associated duplex display circuit with the diodes on two channels 72 and 74. First channel 72 includes diodes 76, while second channel 74 includes diodes 78. Each segment 70 includes a first diode 76 of a first color and a second diode 78 of a second color. The first and second diodes 76 and 78, respectively, connect to the microcontroller (MCU/DRIVER) as indicated.

In this duplex drive arrangement two LEDs with different colors are placed within each segment 70. Also, there are two methods to make each segment change its color. In the first approach, a digital timing pulse is utilized. The first and second channels of the display are connected to the MCU/DRIVER channel control port, and then the two LEDs of each segment 70 are grouped together (or each LED) and connected to the MCU/DRIVER segment control port. The MCU/DRIVER will output different timing signals to both ports to control the brightness and on/off of each LED. In the second approach, analog control is utilized. The channels of the LED display are connected to the MCU/DRIVER channel control port, then the two LEDs are grouped together (or each LED) and connected to the MCU/DRIVER segment control port. The MCU/DRIVER will output an analog signal to each channel and output a timing signal to the segments of the LED display to control the brightness and on/off of each LED to perform the color mixing function.

FIG. 8 is a block diagram illustrating the implementation of the direct drive LED display circuit with an LED display. Input device 86 controls the run/stop of the color mixing of the LEDs and enters the required information for display. The display itself is indicated at 80. The microcontroller unit (MCU) 82 outputs signals through the segment control port to generate timing patterns and control the brightness of the LEDs to achieve color mixing. Driver circuit 84 actually drives the LEDs although if the driving capability of the MCU is sufficient then the driver circuit 84 may be omitted. Either of the two approaches (digital timing pulse or analog) may be taken to make each segment change its color.

FIG. 9 is a block diagram illustrating the implementation of the multiplex LED display circuit with an LED display. Input device 96 controls the run/stop of the color mixing of the LEDs and enters the required information for display. The display itself is indicated at 90. The microcontroller unit (MCU) 92 outputs signals through the segment control port and channel control port to generate timing patterns and control the brightness of the LEDs to achieve color mixing. Driver circuit 94 actually drives the LEDs although if the driving capability of the MCU is sufficient then the driver circuit 94 may be omitted. Either of the two approaches (digital timing pulse or analog) may be taken to make each segment change its color.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A segmented display comprising:
a display including a plurality of segments, each segment including a light emitting device operative to produce a plurality of colors; and
a controller that drives the segments on an individual basis to allow selective illumination of segments on the display to provide the desired illumination pattern with the illuminated segments,
wherein the segments are driven to produce a dynamic display that creates a color changing effect in various segments when displaying the desired illumination pattern.

2. The display of claim 1 wherein the display segments are arranged in a form for a digital clock.

3. The display of claim 1 wherein the light emitting devices are light emitting diodes (LEDs).

4. A segmented display comprising:
a display including a plurality of segments, each segment including a cluster of light emitting diodes (LEDs) to produce a plurality of colors; and
a controller that drives the segments on an individual basis to allow selective illumination of segments on the display to provide the desired illumination pattern with the illuminated segments,
wherein the segments are driven to produce a dynamic display that creates a color changing effect in various segments when displaying the desired illumination pattern.

5. The display of claim 4 wherein the LEDs are arranged in a single channel containing LEDs of a plurality of colors and wherein the controller drives a segment by individually driving LEDs of different colors in the same cluster to produce the color changing effect.

6. The display of claim 4 wherein the LEDs are arranged in at least two channels with a cluster including LEDs from different channels and wherein the controller drives a segment by individually driving LEDs of different channels in the same cluster to produce the color changing effect.

7. The display of claim 4 wherein the display segments are arranged in a form for a digital clock.

8. A digital clock comprising:
a housing;
a display secured to the housing, the display including a plurality of segments, each segment including a light emitting device operative to produce a plurality of colors; and
a controller that drives the segments on an individual basis to allow selective illumination of segments on the display to provide the desired illumination pattern for the clock with the illuminated segments,
wherein the segments are driven to produce a dynamic display that creates a color changing effect in various segments when displaying the desired illumination pattern.

9. The digital clock of claim 8 wherein the display segments are arranged in a form for a multi-function digital clock and include additional segments for functions in addition to time display.

10. The digital clock of claim 8 wherein the light emitting devices are light emitting diodes (LEDs).

11. The digital clock of claim 10 wherein the LEDs are arranged in a single channel containing LEDs of a plurality of colors and wherein the controller drives a segment by individually driving LEDs of different colors in the same cluster to produce the color changing effect.

12. The digital clock of claim 10 wherein the LEDs are arranged in at least two channels with a cluster including LEDs from different channels and wherein the controller drives a segment by individually driving LEDs of different channels in the same cluster to produce the color changing effect.
